(19) United States
(12) Patent Application Publication
(10) Pub. No.: US 2018/0236682 A1
(43) Pub. Date: Aug. 23, 2018

(54) HOLE PUNCHING DEVICE, FINISHER, AND IMAGE FORMING SYSTEM

(71) Applicant: KYOCERA Document Solutions Inc., Osaka (JP)

(72) Inventor: Shinya Aono, Osaka (JP)

(21) Appl. No.: 15/889,293

(22) Filed: Feb. 6, 2018

(30) Foreign Application Priority Data
Feb. 23, 2017 (JP) 2017-032324

(51) Int. Cl. B26F 1/14; H02K 7/075; H02P 3/12; G03G 15/00

(52) U.S. Cl. CPC B26F 1/14; H02K 7/075; B26F 2210/02; G03G 15/6582; H02P 3/12

(57) ABSTRACT

The hole punching device includes rotary-to-reciprocating motion converters that convert rotational motion of a punch shaft connected to a punch motor into up-and-down motion of punch blades, and a short circuiting switch that short-circuits between terminals of the punch motor. The hole punching device further includes a braking current detector that detects braking current flowing through inter-terminal resistance of the punch motor, a braking current comparison unit that turns on the short circuiting switch once and compares a detected braking-current value detected by the braking current detector with a preset reference braking-current value, and a brake time determination unit that determines the time to turn on the short circuiting switch to apply a short circuit brake based on the comparison result obtained by the braking current comparison unit.

### CROSS REFERENCE TO RELATED APPLICATIONS

This application claims priority to Japanese Patent Application No. 2017-32324, which was filed Feb. 23, 2017, and is incorporated herein by reference in its entirety.

### BACKGROUND

This disclosure relates to a hole punching device that makes holes in paper, a finisher including the hole punching device, and an image forming system including the finisher.

Conventionally known hole punching devices for making holes in paper include a punch blade that moves up and down to punch holes in paper, a punch motor, and a rotary-to-reciprocating motion converter that converts rotational motion of the punch motor into up-and-down motion of the punch blade.

Generally, these hole punching devices make holes for a short time, for example, for a few tens of milliseconds, and such a short time punching operation entails significant load changes. To deal with the load changes, a DC motor is frequently used as the punch motor; however, the DC motor has a high inertia. Such a DC motor rotating at a high speed cannot stop upon braking (short-circuit braking or reverse braking), but keeps rotating due to the inertia, and therefore it is difficult to stop the punch blade at a base position.

A typical hole punching device that has been proposed to solve the problem adopts a technique of changing the time to apply a brake, more specifically, changing the position to start stopping the motor in accordance with the amount that the motor has been driven within a predetermined time period while the motor is in operation.

### SUMMARY

The hole punching device according to the present disclosure includes punching blades that move up and down to make holes in paper, a punch motor, rotary-to-reciprocating motion converters that convert rotational motion of a punch shaft, which is connected to the punch motor, into up-and-down motion of the punch blades, and a short circuiting switch that short-circuits between terminals of the punch motor, and performs a punching process for making holes by rotating the punch shaft from a base position, and a braking process for turning on the short circuiting switch to apply a short circuit brake to the rotating punch shaft to stop the punch shaft at the base position. The hole punching device includes a braking current detector that detects the value of braking current flowing through inter-terminal resistance of the punch motor, a braking current comparison unit that turns on the short circuiting switch once after the punching process and compares a detected braking-current value detected by the braking current detector with a preset reference braking-current value, and a brake time determination unit that determines the time to turn on the short circuiting switch to apply a short circuit brake based on the comparison result obtained by the braking current comparison unit.

In the hole punching device according to the disclosure, the braking time determination unit can delay the time to start applying a short circuit brake when a detected braking-current value is greater than the reference braking-current value, and can advance the time to start applying a short circuit brake when the detected braking-current value is smaller than the reference braking-current value.

In the hole punching device according to the disclosure, the braking time determination unit can shorten a braking period in which a short circuit brake is applied when the detected braking-current value is greater than the reference braking-current value, and can extend the braking period in which a short circuit brake is applied when the detected braking-current value is smaller than the reference braking-current value.

The hole punching device according to the disclosure further includes a rotation detector that detects the rotation of the punch shaft and outputs a rotational position signal associated with the detected rotation, and the braking current comparison unit measures the rotational speed of the punch shaft immediately before the short circuiting switch is turned on based on the rotational position signal, and compares the reference braking-current value corresponding to the measured rotational speed with the detected braking-current value.

In addition, a finisher according to the disclosure receives paper and performs various post-printing processes on the paper, and includes the aforementioned hole punching device.

Furthermore, an image forming system according to the disclosure includes the aforementioned finisher equipped with the hole punching device, and an image forming apparatus outputting the paper with an image formed thereon to the finisher.

### BRIEF DESCRIPTION OF THE DRAWINGS

FIG. 1 is a system configuration diagram of an image forming system including a finisher and an image forming apparatus; the finisher having an embodiment of a hole punching device according to the present disclosure.

FIG. 2 is a perspective view showing the configuration of the hole punching device shown in FIG. 1.

FIG. 3 is a perspective view showing the configuration of a rotation detector and a base-position detector shown in FIG. 2.

FIG. 4 is a block diagram schematically showing the configuration of the embodiment of the hole punching device according to the disclosure.

FIG. 5 is a waveform diagram for explaining a braking process when a detected braking-current value is equal to a reference braking-current value.

FIG. 6 is a waveform diagram for explaining the braking process when a detected braking-current value is greater than the reference braking-current value.

FIG. 7 is a waveform diagram for explaining the braking process when a detected braking-current value is smaller than the reference braking-current value.

FIG. 8A is a waveform diagram for explaining how the embodiment of the hole punching device according to the disclosure performs position correction.

FIG. 8B is a waveform diagram for explaining how the embodiment of the hole punching device according to the disclosure performs position correction.

FIG. 8C is a waveform diagram for explaining how the embodiment of the hole punching device according to the disclosure performs position correction.

### DETAILED DESCRIPTION

With reference to the drawings, an embodiment of the present disclosure will be described in detail below.

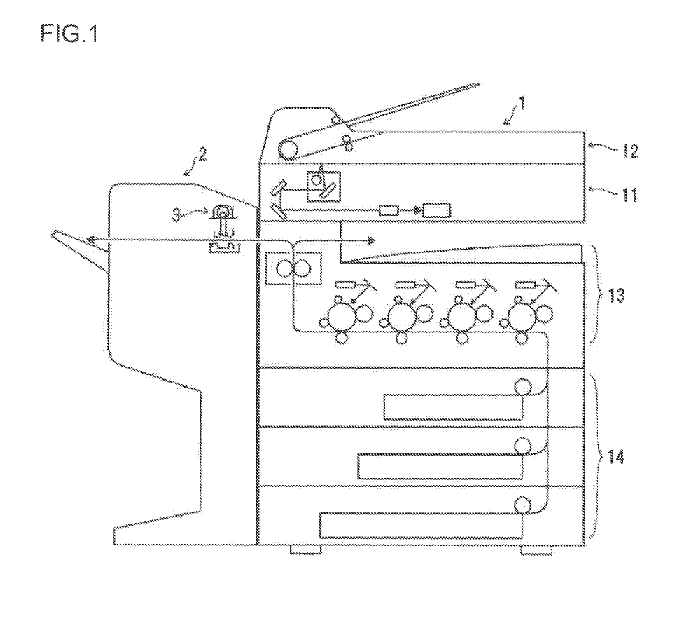

Referring to FIG. 1, the image forming system according to an embodiment includes an image forming apparatus 1 that forms an image on paper and outputs the paper, and a finisher 2 that receives the paper output from the image forming apparatus 1 and performs various post-printing operations on the received paper.

The image forming apparatus 1 is a copier, an multifunctional peripheral/printer/product (MFP), or any other machines using electrophotography, and includes a document reading unit 11, a document feeding unit 12, an image forming unit 13, and a paper feeding unit 14. The image forming apparatus 1 executes image forming operation for a copy job, a scan job, a facsimile job, a printer job, and other kinds of jobs in response to an instruction accepted by the image forming apparatus 1 logged in through user-authentication.

The document reading unit 11 includes a light source that emits light to a document placed on a document table or fed by the document feeding unit 12, and a photoelectric converter, which may be a CCD, that converts reflected light from the document into image data of the document.

The image forming unit 13 forms a toner image based on print data, transfers the formed toner image onto paper fed by the paper feeding unit 14, and fuses the toner image transferred on the paper at a predetermined fusing temperature to produce a printed record.

The finisher 2 includes a hole punching device 3. The finisher 2 can be equipped with a stapling device that stacks a plurality of sheets of paper and staples the stack, a sheet folding device that folds paper, and some other types of devices.

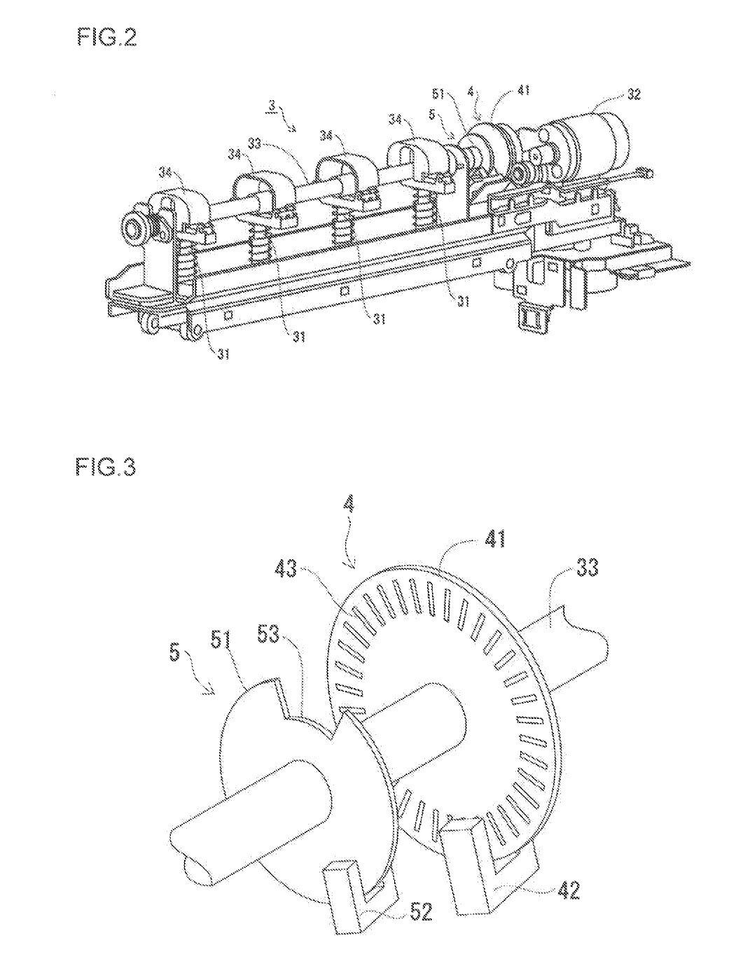

Referring to FIG. 2, the hole punching device 3 includes punch blades 31 that are arranged in the direction of the width of paper, spaced at predetermined intervals, and move up and down to make holes in paper, a punch motor 32, a punch shaft 33 that is connected to a rotary shaft of the punch motor 32 with a gear train interposed therebetween, rotary-to-reciprocating motion converters 34 that convert rotational motion of the punch shaft 33 into up-and-down motion of the punch blades 31, a rotation detector 4, and a base-position detector 5.

The rotary-to-reciprocating motion converters 34 move the punch blades 31 up and down with rotation of the punch shaft 33, for example, by engaging support members supporting the punch blades 31 with the outer edges of eccentric cams supported by the punch shaft 33. In this case, rotation of the punch shaft 33 allows distal edge parts of the eccentric cams, each of which is away from the center of rotation, to engage with the support members of the punch blades 31 to perform a punching process for making holes. On the contrary, when proximal edge parts of the eccentric cams, each of which is near the center of rotation, are engaged with the support members of the punch blades 31, the punch blades 31 lose contact with the paper. The position where the punch blades 31 are not in contact with paper is referred to as a base position where the punch blades 31 are on standby for the next punching process.

The rotation detector 4 detects rotation of the punch shaft 33 (eccentric cam). Referring to FIGS. 2 and 3, the rotation detector 4 includes a pulse plate 41 attached to an end portion of the punch shaft 33, and a rotation amount detection sensor 42 that is composed of a transmission-type photointerrupter or other components.

The pulse plate 41 is in the shape of a disk, and the punch shaft 33 passes through a midsection (the center) of the pulse plate 41. The pulse plate 41 has a plurality of slits 43 spaced equally along the entire periphery in the circumference direction. The rotation amount detection sensor 42 is disposed to face the path along which the slits 43 rotate, and outputs pulses representing the presence or absence (pass or block) of the slits 43 as rotational position signals. In this embodiment, the pulse plate 41 has thirty six slits 43. The rotation amount detection sensor 42 detects one slit 43 while the pulse plate 41 rotates 10 degrees, and detects the thirty six slits 43 while the pulse plate 41 rotates one time. Thus, the rotational position signal output from the rotation detector 4 is a pulse signal output every time the punch shaft 33 rotates 10 degrees.

The base-position detector 5 detects the base position of the punch shaft 33 (eccentric cam). Referring to FIGS. 2 and 3, the base-position detector 5 includes a base-position detection plate 51 attached to an end portion of the punch shaft 33, and a base-position detection sensor 52 that is composed of a transmission-type photointerrupter or other components.

The base-position detection plate 51 is in the shape of a disk, and the punch shaft 33 passes through a midsection (the center) of the base-position detection plate 51. The base-position detection plate 51 has a notch 53 formed for detecting the base position. The notch 53 extends over an angle corresponding to a few slits 43 in the pulse plate 41. The base-position detection sensor 52 is disposed to face the path along which the notch 53 rotates, and outputs pulses representing the presence or absence (pass or block) of the notch 53 as base position signals. The base-position detection sensor 52 detects one pulse while the base-position detection plate 51 rotates one time. The base position set in this embodiment is the position at which the rotation amount detection sensor 42 detects two slits 43 after the base-position detection sensor 52 detects the notch 53.

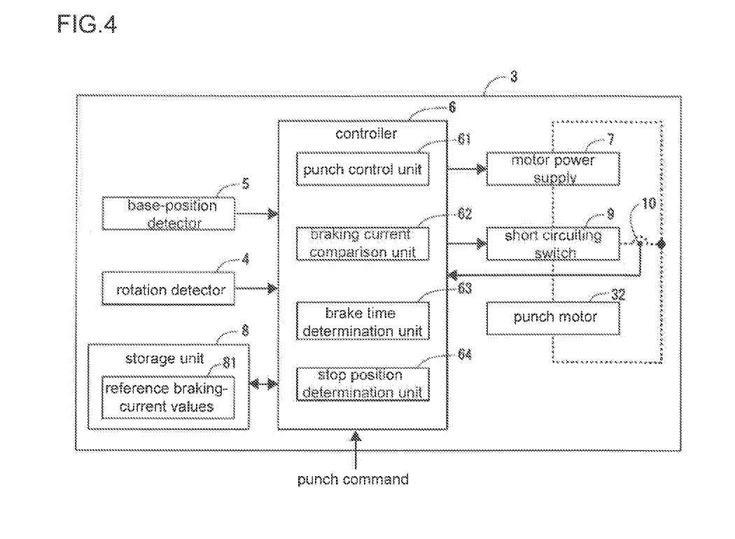

FIG. 4 is a block diagram schematically showing the configuration of the hole punching device 3.

In addition to the aforementioned components, the hole punching device 3 includes a controller 6, a motor power supply 7 for supplying power to the punch motor 32, a storage unit 8, a short circuiting switch 9, and a braking current detector 10.

The controller 6 is an information processing unit, like a microcomputer, including a central processing unit (CPU), a read only memory (ROM), a random access memory (RAM), and some other components. The ROM stores control programs for controlling the operation of the hole punching device 3. The CPU of the controller 6 retrieves a control program stored in the ROM, and expands it on the RAM to control the entire device. The controller 6 also functions as a punch control unit 61, a braking current comparison unit 62, a brake time determination unit 63, and a stop position determination unit 64.

The storage unit 8 is a storage device, such as a semiconductor memory and a hard disk drive (HDD), and stores reference braking-current values 81. The reference braking-current values 81 are values of braking current in accordance with rotational speed of the punch shaft 33 when the inter-terminal resistance (hereinafter, referred to as coil resistance) of the punch motor 32 has a standard temperature (e.g., 20° C.). The dielectric voltage generated upon short circuit braking can be determined by multiplying the rotational speed of the punch shaft 33 by a counter-electromotive force constant. The braking current can be determined by subtracting the dielectric voltage generated upon short circuit braking by the resistance value of the coil resistance at the standard temperature. Therefore, the reference braking-current values 81 in accordance with the rotational speed of the punch shaft 33 can be calculated by storing the resistance values of the coil resistance at the standard temperature and the counter-electromotive force constants.

The short circuiting switch 9 is a switch to short-circuit the terminals of the punch motor 32 to apply a short circuit brake.

The braking current detector 10 detects braking current flowing between terminals of the punch motor 32 during short circuit braking, and outputs the detected braking-current value to the controller 6.

The punch control unit 61 performs a punching process in which the punch shaft 33 is rotated from the base position to punch a hole. In response to a punch command input through the host apparatus, the punch control unit 61 starts the punching process by controlling the motor power supply 7 to supply positive voltage to the punch motor 32. With the start of the punching process, the punch control unit 61 starts counting pulses of rotational position signals output from the rotation detector 4. When the pulse count reaches a preset value (19 in this embodiment), the punch control unit 61 controls the motor power supply 7 to stop supplying voltage to the punch motor 32, and completes the punching process.

After the voltage supply from the motor power supply 7 to the punch motor 32 is stopped, the braking current comparison unit 62 turns on the short circuiting switch 9 at a predetermined time for a predetermined period to perform braking current value checking operation, more specifically to check the value of braking current flowing through the coil resistance of the punch motor 32 at short circuit braking. The braking current comparison unit 62 compares the braking current value detected by the braking current detector 10 (hereinafter, referred to as a detected braking-current value) with a reference braking-current value 81, and outputs the comparison result to the brake time determination unit 63.

Based on the comparison result by the braking current comparison unit 62, the brake time determination unit 63 determines the time to start applying a short circuit brake (hereinafter, sometimes referred to as brake start time), and turns on the short circuiting switch 9 at the determined brake start time to perform a braking process, more specifically to stop the punch shaft 33 at the base position.

The stop position determination unit 64 determines whether the punch shaft 33 has stopped at the base position through the short circuit brake process. If it is determined that the punch shaft 33 has not stopped at the base position, the stop position determination unit 64 causes the motor power supply 7 to supply positive or negative voltage to the punch motor 32 to correct the rotational position of the punch shaft 33.

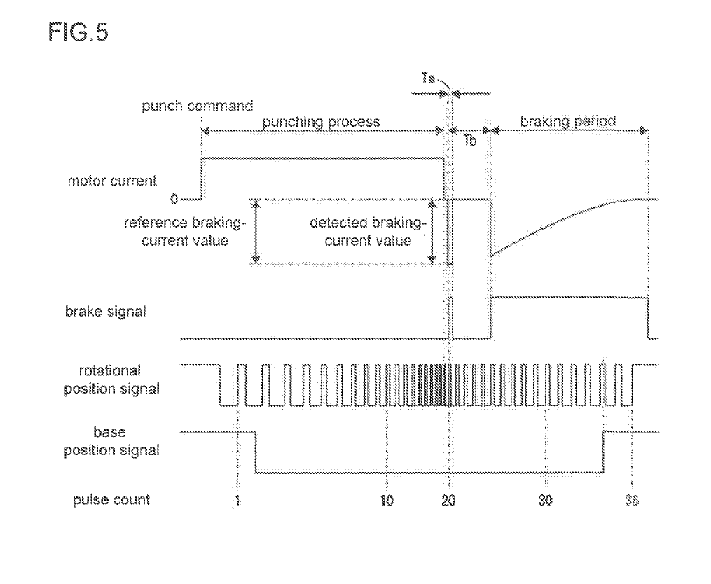

Description will be made about the punching process and the braking process by the hole punching device 3 with reference to FIG. 5 to FIG. 8C.

Referring to FIG. 5, the controller 6 functions as a punch control unit 61 in response to an input of a punch command from the host apparatus. The punch control unit 61 starts the punching process by controlling the motor power supply 7 to start supplying positive voltage to the punch motor 32. This feeds positive motor current to the coil resistance of the punch motor 32, thereby rotating the punch shaft 33. The rotation of the punch shaft 33 engages distal edge parts of the eccentric cams, each of which is away from the center of rotation, with the support members of the punch blades 31 such that the punch blades 31 are pushed into the paper to make holes.

With the start of the punching process, the punch control unit 61 starts counting pulses of rotational position signals output from the rotation detector 4. When the pulse count reaches 19, the punch control unit 61 controls the motor power supply 7 to stop supplying voltage to the punch motor 32, and completes the punching process.

At the completion of the punching process by the punch control unit 61, the controller 6 functions as a braking current comparison unit 62. After the motor power supply 7 stops supplying voltage to the punch motor 32 to complete the punching process, the braking current comparison unit 62 turns on the short circuiting switch 9 at a predetermined time (at the time at which the pulse count reaches 20 in the example shown in FIG. 5) for a predetermined period in time Ta to perform braking current checking operation. By turning on the short circuiting switch 9, a braking current corresponding to the rotational speed flows through the coil resistance, and the detected braking-current value is input to the braking current comparison unit 62. The predetermined period in time Ta is provided for the braking current detector 10 to detect the braking current value.

As part of the braking current value checking operation, the braking current comparison unit 62 measures the rotational speed of the punch shaft 33 immediately before the short circuiting switch 9 is turned on by measuring the pulse period based on the rotational position signal output from the rotation detector 4, and identifies a reference braking-current value 81 corresponding to the measured rotational speed.

The braking current comparison unit 62 compares the detected braking-current value with the identified reference braking-current value 81, and outputs the comparison result to the brake time determination unit 63. The reference braking-current value 81 is a braking current value when the coil resistance has a standard temperature. Therefore, the detected braking-current value greater than the reference braking-current value 81 denotes that the temperature of the coil resistance is higher than the standard temperature, while the detected braking-current value smaller than the reference braking-current value 81 denotes that the temperature of the coil resistance is lower than the standard temperature.

Next, the brake time determination unit 63 determines the time to start applying a short circuit brake based on the comparison result from the braking current comparison unit 62, and turns on the short circuiting switch 9 at the determined time to perform a braking process for stopping the punch shaft 33 at the base position.

The brake start time when the detected braking-current value is equal to the reference braking-current value 81 is set as a reference time in advance in the brake time determination unit 63. The reference time is a time designed to stop the punch shaft 33 at the base position. Specifically, on the condition that the coil resistance has a standard temperature, if the short circuiting switch 9 is turned on at the reference time to start applying a short circuit brake, the punch shaft 33 is supposed to stop at the base position. In this embodiment, referring to FIG. 5, the reference time is set to a time that is Tb seconds after the pulse count has reached 20.

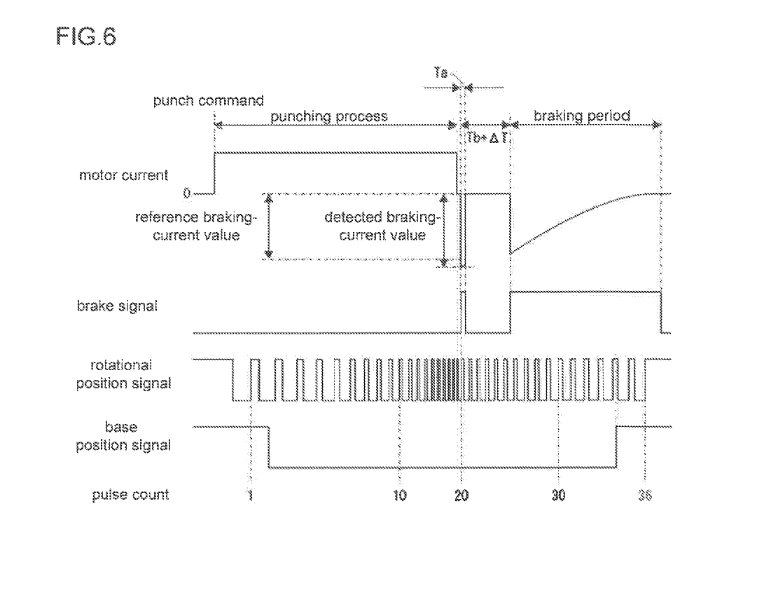

When a detected braking-current value is greater than the reference braking-current value 81 as shown in FIG. 6, the brake time determination unit 63 determines a time that is later than the reference time as a brake start time. The brake time determination unit 63 calculates adjustment time ΔT, which becomes longer as the difference between the detected braking-current value and reference braking-current value 81 is wider. Then, the brake time determination unit 63 adds the adjustment time ΔT to the reference time of Tb seconds, and determines the resultant time as the brake start time.

In the case where the coil resistance has a temperature higher than the standard temperature, the detected braking-current value becomes greater than the reference braking-current value 81. Where a braking current is I, and a torque constant is Kt, braking torque T is expressed by T=I×Kt. Therefore, if the detected braking-current value is greater than the reference braking-current value 81, the braking torque T becomes larger, thereby making the short circuit brake more effective. Determining a time that is later than the reference time as a brake start time can consequently prevent the punch shaft 33 from stopping before the base position.

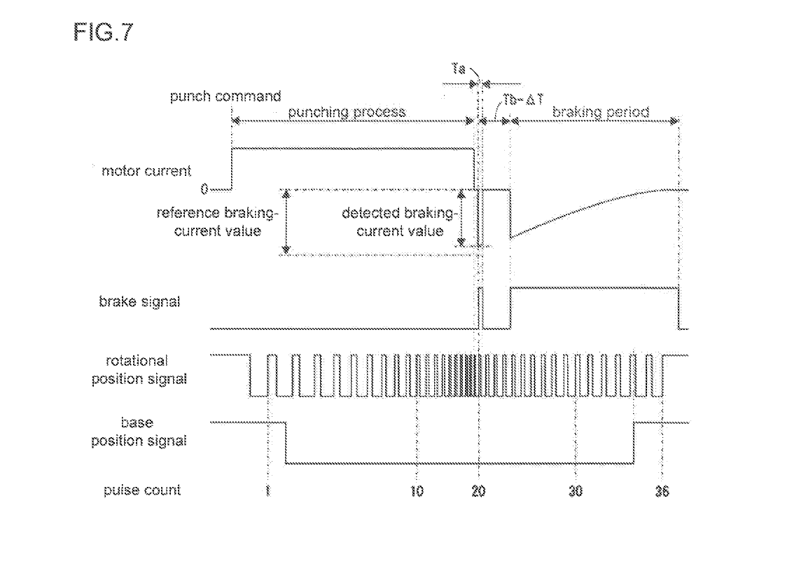

When a detected braking-current value is smaller than the reference braking-current value 81 as shown in FIG. 7, the brake time determination unit 63 determines a time that is earlier than the reference time as a brake start time. The brake time determination unit 63 calculates adjustment time ΔT, which becomes longer as the difference between the detected braking-current value and reference braking-current value 81 is wider. Then, the brake time determination unit 63 subtracts the adjustment time ΔT from the reference time of Tb seconds, and determines the resultant time as the brake start time.

In the case where the coil resistance has a temperature lower than the standard temperature, the detected braking-current value becomes smaller than the reference braking-current value 81. Where a braking current is I, and a torque constant is Kt, braking torque T is expressed by T=I×Kt. Therefore, if the detected braking-current value is smaller than the reference braking-current value 81, the braking torque T becomes smaller, thereby making the short circuit brake less effective. Determining a time that is earlier than the reference time as a brake start time can consequently prevent the punch shaft 33 from stopping over the base position.

The temperature of the coil resistance cannot be directly monitored because the coil resistance is near a rotor in the punch motor 32. However, the temperature variations in the coil resistance can be indirectly monitored by monitoring braking current. Therefore, the brake start time can be updated every time the temperature of the coil resistance increases due to self-heating caused by continuous running or other reasons.

By the way, the rotational position signal output from the rotation detector 4 can provide a pulse count to obtain the rotational position of the punch shaft 33, and can also provide a pulse period by measuring the pulse count to obtain the rotational speed of the punch shaft 33. Therefore, although a time after the punch shaft 33 has reached a predetermined rotational position (count of 20) is specified as a brake start time in this embodiment, a rotational position of the punch shaft 33 can be used as a brake start time.

Furthermore, although the brake start time is controlled in this embodiment, a braking period (distance or duration) can be controlled in accordance with the comparison result between the detected braking-current value and reference braking-current value 81. In this case, a braking period when the detected braking-current value is equal to the reference braking-current value 81 is set as a reference period in advance. When the detected braking-current value is greater than the reference braking-current value 81, the reference period is set shorter in accordance with the difference, and when the detected braking-current value is smaller than the reference braking-current value 81, the reference period is set longer in accordance with the difference. During the braking period, the short circuit brake does not need to be continuously applied, but can be applied intermittently. Alternatively, the braking period can be set so as to continuously follow the braking current value checking operation.

Next, the controller 6 functions as a stop position determination unit 64 that determines whether the punch shaft 33 has stopped at the base position through the braking process.

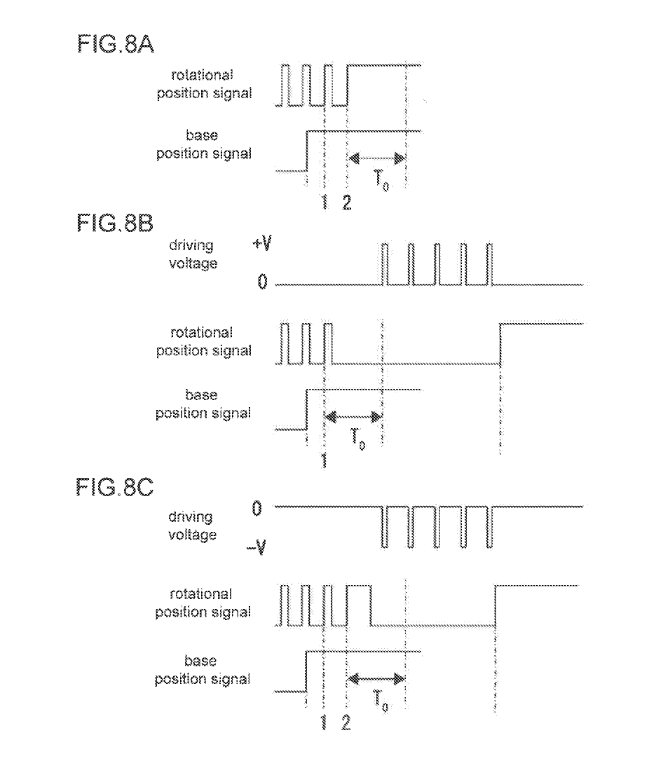

As shown in FIG. 8A, the base-position detection sensor 52 detects the notch 53 and outputs a base position signal raised high, and then the rotation amount detection sensor 42 detects two slits 43 and outputs a rotational position signal with two rising edges. If the next rotational position signal is found to not have a rising edge after a predetermined time period T0 has elapsed, the stop position determination unit 64 determines that the punch shaft 33 has stopped at the base position and completes the punching operation.

As shown in FIG. 8B, the base-position detection sensor 52 detects the notch 53 and outputs a base position signal raised high, and then if a predetermined time period T0 has elapsed before the rotation amount detection sensor 42 detects two slits 43 and outputs a rotational position signal with two rising edges, the stop position determination unit 64 determines that the punch shaft 33 has stopped before the base position and corrects the rotational position of the punch shaft 33. If the punch shaft 33 has stopped before the base position, the stop position determination unit 64 causes the motor power supply 7 to intermittently supply positive voltage (+V) to the punch motor 32.

As shown in FIG. 8C, the base-position detection sensor 52 detects the notch 53 and outputs a base position signal raised high, and then the rotation amount detection sensor 42 detects two slits 43 or more and outputs a rotational position signal with two rising edges. If the next rotational position signal is found to have a falling edge before the predetermined time period T0 has elapsed, the stop position determination unit 64 determines that the punch shaft 33 has stopped over the base position and corrects the rotational position of the punch shaft 33. If the punch shaft 33 has stopped over the base position, the stop position determination unit 64 causes the motor power supply 7 to intermittently supply negative voltage (−V) to the punch motor 32.

It is preferable to correct the reference time in accordance with the determination result by the stop position determination unit 64 to effect the correction for the next braking process. In this case, if the punch shaft 33 has stopped before the base position, the reference time is moved ahead, and if the punch shaft 33 has stopped over the base position, the reference time is delayed. This can correct the variations inherent to the apparatus as well as the temperature variations in the coil resistance.

As described above, the present embodiment provides a hole punching device 3 including punching blades 31 that move up and down to make holes in paper, a punch motor 32, rotary-to-reciprocating motion converters 34 that convert rotational motion of a punch shaft 33, which is connected to the punch motor 32, into up-and-down motion of the punch blades 31, and a short circuiting switch 9 that short-circuits between terminals of the punch motor 32, and performing a punching process for making holes by rotating the punch shaft 33 from a base position, and a braking process for turning on the short circuiting switch 9 to apply a short circuit brake to the rotating punch shaft 33 to stop the punch shaft 33 at the base position. The hole punching device further includes a braking current detector 10 that detects braking current flowing through inter-terminal resistance of the punch motor 32, a braking current comparison unit 62 that turns on the short circuiting switch 9 once after the punching process and compares a detected braking-current value detected by the braking current detector 10 with a preset reference braking-current value, and a brake time determination unit 63 that determines the time to turn on the short circuiting switch 9 to apply a short circuit brake based on the comparison result obtained by the braking current comparison unit 62.

According to the configuration, variations in braking torque T caused by temperatures of the coil resistance are detected in the form of detected braking-current values, and a short circuit brake can be adjusted in accordance with the detected braking-current values, thereby stopping the punch shaft more accurately at an aimed base position.

According to the embodiment, the brake time determination unit 63 delays the time to start applying a short circuit brake when a detected braking-current value is greater than the reference braking-current value, and advances the time to start applying a short circuit braking when the detected braking-current value is smaller than the reference braking-current value.

In addition, according to the embodiment, the brake time determination unit 63 shortens the braking period to apply a short circuit brake when a detected braking-current value is greater than the reference braking-current value, and extends the braking period to apply a short circuit brake when the detected braking-current value is smaller than the reference braking-current value.

In addition, the hole punching device according to the embodiment includes the rotation amount detection sensor 42 that detects the rotation of the punch shaft 33 and outputs a rotational position signal, and the braking current comparison unit 62 measures the rotational speed of the punch shaft 33 immediately before the short circuiting switch 9 is turned on based on the rotational position signal, and compares the reference braking-current value corresponding to the measured rotational speed and the detected braking-current value.

According to the configuration, variations in braking torque T caused by the temperatures of the coil resistance can be accurately detected as a detected braking-current value.

The present disclosure is not limited to the embodiment described above. It is apparent that various changes and modifications can be made within the scope of the technical idea of this disclosure.

What is claimed is:

1. A hole punching device including a punching blade that moves up and down to make a hole in paper, a punch motor, a rotary-to-reciprocating motion converter that converts rotational motion of a punch shaft, which is connected to the punch motor, into up-and-down motion of the punch blade, and a short circuiting switch that short-circuits between terminals of the punch motor, and performing a punching process for making a hole by rotating the punch shaft from a base position, and a braking process for turning on the short circuiting switch to apply a short circuit brake to the rotating punch shaft to stop the punch shaft at the base position, the hole punching device comprising:
a braking current detector that detects the value of braking current flowing through inter-terminal resistance of the punch motor;
a braking current comparison unit that turns on the short circuiting switch once after the punching process, and compares a detected braking-current value detected by the braking current detector with a preset reference braking-current value; and
a brake time determination unit that determines a time to turn on the short circuiting switch to apply a short circuit brake based on the comparison result obtained by the braking current comparison unit.

2. The hole punching device according claim 1, wherein
when the detected braking-current value is greater than the reference braking-current value, the brake time determination unit delays the time to start applying the short circuit brake, while when the detected braking-current value is smaller than the reference braking-current value, the brake time determination unit advances the time to start applying the short circuit brake.

3. The hole punching device according claim 1, wherein
when the detected braking-current value is greater than the reference braking-current value, the brake time determination unit shortens a braking period to apply the short circuit brake, while when the detected braking-current value is smaller than the reference braking-current value, the brake time determination unit extends the braking period to apply the short circuit brake.

4. The hole punching device according claim 1, comprising
a rotation detector that detects rotation of the punch shaft and outputs a rotation position signal associated with the detected rotation, wherein
the braking current comparison unit measures a rotational speed of the punch shaft immediately before the short circuiting switch is turned on based on the rotational position signal, and compares the reference braking-current value corresponding to the measured rotational speed with the detected braking-current value.

5. A finisher that receives paper and performs various post-printing processes on the paper, comprising
the hole punching device according claim 1.

6. An image forming system comprising:
the finisher according to claim 5; and
an image forming apparatus that outputs the paper with an image formed thereon to the finisher.
